(19) United States
(12) Patent Application Publication
(10) Pub. No.: US 2023/0231460 A1
(43) Pub. Date: Jul. 20, 2023

(54) Self-Powered Internal Energy and Power Generation System and Process

(71) Applicants: Nilo H. Soriano, East Brunswick, NJ (US); Ronald S. Padiernos, Pampanga (PH); Pathwalker Industries Corporation, Pampanga (PH)

(72) Inventors: Ronald S. Padiernos, Pampanga (PH); Mario De Vera Paningbatan, Pampanga (PH)

(21) Appl. No.: 16/646,378

(22) PCT Filed: Oct. 5, 2017
(86) PCT No.: PCT/PH2017/000009

§ 371 Date: Mar. 11, 2020

(30) Foreign Application Priority Data
Sep. 14, 2017 (PH) 12017000264

(51) Int. Cl. H02K 53/00

(52) U.S. Cl. CPC H02K 53/00

(57) ABSTRACT

The invention relates to an energy and power generation system and process, especially self-powered motor and generator/alternator set-up. The system has at least one upsized drive shaft adapted as one of the main elements thereof including an upsized main body of non-typical size having substantially and proportionately enlarged diameter and/or length based on typical standard drive shaft sizes normally and correspondingly adapted for power generation systems or devices of commensurate capacity ratings, preferably motor-generator systems, generators or alternators, or electric motors. When in inertial rotation, the upsized shaft inertially produces/generates and adds input power/energy to the subsequent electrical input power/energy derived from the motor resulting in an overall input power/energy that is efficiently converted/transformed by the generator/alternator into electrical output power/energy that is greater than the electrical input power/energy supplied to the motor. The excess useful electrical output power/energy is used for other loads and/or charging/recharging a power source or battery pack that is used to initially start up the motor.

### FIELD OF THE INVENTION

The invention generally relates to power and energy generation, and more particularly to a self-powered internal energy and power generation system and process.

### BACKGROUND OF THE INVENTION

It is well known in this modern times that technology advances faster than the world’s energy sources could supply. To keep up with changing times and rapidly increasing demands of power/energy, higher energy generation capacity worldwide is needed to answer for the requirements. The process of transforming electrical power/energy from other forms of energy, thus, has always been the center of attention anywhere in the world.

There are fundamental methods of directly transforming other forms of energy into electrical energy, namely: static electricity, from the physical separation and transport of charge like, triboelectric effect and lightning; electromagnetic induction, where an electrical generator, dynamo or alternator transforms kinetic energy (energy of motion) into electricity; electrochemistry, the direct transformation of chemical energy into electricity, as in a battery, fuel cell or nerve impulse; photoelectric effect, the transformation of light into electrical energy, as in solar cells; thermoelectric effect, direct conversion of temperature differences to electricity, as in thermocouples and thermopiles; piezoelectric effect, from the mechanical strain of electrically anisotropic molecules or crystals; and nuclear transformation, the creation and acceleration of charged particles like betavoltaics or alpha particle emission.

The existing power plants rely mainly on coal, nuclear, natural gas, hydroelectric and petroleum with a small amount from solar energy, tidal harnesses, wind generators and geothermal sources, all of which have numerous disadvantages as follows.

Coal is nonrenewable energy source because it takes millions of years to create, further, it is fast depleting. Fossil fuels provide around 66% of the world’s electrical power, and 95% of the world’s total energy demands (including heating, transport, electricity generation and other uses). Burning fossil fuels releases carbon dioxide, which is a powerful greenhouse gas that contributes to global warming.

Nuclear energy can be used for production and proliferation of nuclear weapons, a major threat to the world as they can cause large scale devastation. Building nuclear power plant is capital extensive. The nuclear reactors will work only as long as uranium is available; its extinction will cause grave problem.

Natural gas besides being finite is highly volatile and can be dangerous. Detection of leak is very difficult because it is colorless, odorless and tasteless. Construction and managing pipelines likewise is expensive.

Hydroelectric power dams are extremely costly and must be built at a very high standard. Building of large dams can cause serious geological damage as they can damage the surrounding environment and alter the quality of the water by creating low dissolved oxygen levels, which impacts fish and surrounding ecosystems. They also take up a great deal of space and can impose on animal, plant and even human environments. During drought, when water is not available, hydro power plants cannot produce electricity.

The depletion of fossil fuels (coal, crude oil and natural gas) had signaled the beginning of intensive program to develop renewable fuel sources (wind, solar and biofuels). Still, the disadvantages of these sources are overwhelming.

Solar energy system has a high investment cost, largely because of the high cost of semi-conducting materials used in building one. Solar panels require a large area for installation to achieve a good level of efficiency. Its efficiency also relies on the location of the sun, although certain components maybe installed to solve this problem. The production of solar energy is influenced by the presence of clouds or pollution in the air. No solar energy will be produced during nighttime although a battery backup system and/or net metering will answer this concern.

Wind power is unreliable. Wind turbines generally produce a lot less electricity thus requiring multiple wind turbines to be built in order to make an impact. Its construction can be very expensive and costly to surrounding wildlife during the process. The noise pollution from commercial wind turbines is sometimes similar to a small jet engine.

The area where a geothermal energy power plant would be built should consist of those suitable hot rocks at just the right depth for drilling. In addition, the type of rock must be easy to drill into. It is important to take care of a geothermal site because if the holes were drilled improperly, then potentially harmful minerals and gas could escape from the ground. These hazardous materials are nearly impossible to get rid of properly. Pollution may occur due to improper drilling at geothermal stations. Unbelievably, it is also possible for specific geothermal area to run dry or lose steam.

Collecting sufficient quantities of waste can be difficult to create biomass energy. Burning the fuel also creates greenhouse gases. Moreover, certain materials used in creating biomass energy are not always available.

Worse, emissions of pollutants and greenhouse gases from electricity generation account for significant portion of world greenhouse gas emissions.

Therefore, there exists a need for power generation system which is a suitable replacement for existing ones that is more, if not equally, as efficient at producing the same amount of energy, without depleting resources and without harming the environment of a finite earth.

In view of the above-discussed shortcomings, drawbacks and problems of fuel-based and nature-energy-based electrical power/energy production/ generation tapping and utilizing natural forces or energies and/or processed fuels, there are numerous attempts to feasibly and practically make and design power/energy generation machines that really work without using these consumable power/energy sources. However, up to the present times, there aren’t any such machines or electrical power/energy generators that are capable of producing and providing useful output power/energy, especially electrical power/energy, and at the same time still has a part of its output power/energy being used to supply electrical power/energy to its prime mover or an electrical motor.

### SUMMARY OF THE INVENTION

The present invention seeks to overcome the shortcomings of the prior art by providing a self-powered internal energy and power generation system and process comprising of motor-driveshaft-generator/altemator set-up that is capable of efficiently generating greater electrical output power/energy than its electrical input power/energy, and still having substantial and significant amount of useful excess/extra power/energy to run/operate other electrical loads. This is achieved by the invention in the provision thereto of a non-typical upsized drive shaft with non-typical enlarged diameter and/or length, connecting/coupling the motor and generator/altemator, that is capable of exponentially adding inertial power/energy to the mechanical power/energy derived from the motor.

It is therefore the primary object of the invention to provide a self-powered internal energy and power generation system and process that is capable of powering itself, and still having substantial and significant amount of excess power/energy for other loads, hence, can subsequently operate/run and generates power/energy without using any fuel.

Another object thereof is to provide a self-powered internal energy and power generation system and process that has capability to run by itself (regeneration process) and increase electricity generation by inertial amplification of mechanical power/energy that is in turn transformed/converted into useful electrical power/energy.

Still another object thereof is to provide a self-powered internal energy and power generation system and process that will help to minimize the effects of pollution as a consequence of industrialization and lower the cost of power/energy production/generation.

Yet another object thereof is to provide a self-powered internal energy and power generation system and process that is capable of helping save mother earth from the greenhouse effect as it involves clean-energy generation and is cost-effective, and is not dependent on wind, sun, water and gas, therefore, the process for regeneration and amplification is predictable. In terms of space required to produce large scale electricity production, it will only consume minimal space as compared to solar, wind, hydro-electric power plants or power grids.

A further object thereof is to provide a self-powered internal energy and power generation system and process that utilizes indigenous materials and simple technology, yet so practical and technically beneficial, thus very economical to manufacture and most marketable to commercialize.

### BRIEF DESCRIPTION OF THE DRAWINGS

Other objects, features and advantages of the invention are better understood and appreciated from the following detailed description made in conjunction with the appended drawings, in which:

FIG. 1 is a schematic view of a preferred embodiment or illustrative example of the system aspect of the present invention; and

FIG. 2 is a process flow diagram of a preferred embodiment or illustrative example of the process aspect of the present invention.

### DETAILED DESCRIPTION

Before describing the invention in detail, it is to be understood that the phraseologies and terminologies employed herein are for purposes of description only to support an enabling disclosure, thus should not be regarded as limiting.

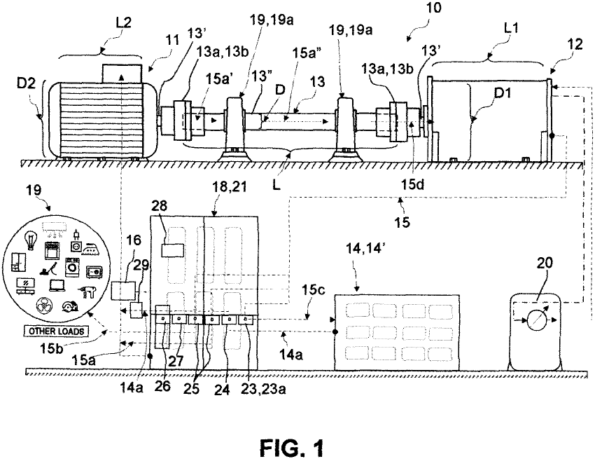

Referring now to the drawings in detail wherein like reference numerals designate the same parts or elements all throughout the description, there is shown in FIG. 1 a self-powered internal energy and power generation system 10 comprising an electric motor 11 mechanically coupled to an altemator/generator 12 through a non-typical upsized drive shaft 13 and initially powered or started up by an initial input power/energy 14a from a power source 14, and subsequently and sustainably powered by a subsequent input power/energy 15a that is sourced from or part of an output power/energy 15 produced or generated by the generator/altemator 12 at an inertially appropriate and/or sufficient-torque-producing rotational speed of the shaft 13 after start-up. The power source 14 for supplying initial start-up/input power 14a to the electric motor 11 is preferably battery or battery pack 14′, grid (not shown), or any forms or types of electrical power-generating sources, or any combinations of any available power sources that are capable of providing electrical output power/energy and/or running the electric motor 11.

The generator/alternator 12 has a higher power capacity rating than that of the motor 11, and is capably, controllably, and compatibly driven rotatably by the motor 11. The motor 11 is capable of driving or rotating the drive shaft 13 and in turn the generator/alternator 12 at the initial start-up and thereafter by the amount of input power/energy 14a,15a supplied thereto that has to be within the motor 11′s capacity rating. Further, the motor 11′s rating capacity, being lower than that of the generator/altemator 12, is compatible with the latter in having relatively lower amperage, voltage, frequency, and/or speed ratings than those of the generator/alternator 12 for the latter’s secure, smooth and/or effectively efficient operation. In addition thereto, the motor 11′s rotational speed and/or input power/energy 14a,15a is capable of being controlled by a speed or voltage/amperage/frequency controller 16 connected thereto.

The upsized drive shaft 13 is of non-typical size having substantially and proportionately enlarged diameter D and/or length L such that the shaft 13 has relatively greater resultant mass and moment of inertia than standard-size drive shaft 13′, which translate into power/energy when the shaft 13 is in an inertially appropriate rotational speed. For an efficient, if not most or highly efficient, generation and/or transformation of power/energy inertially or centrifugally derived from the rotating upsized drive shaft 13, the motor 11 and the generator/altemator 12 are securely and stably connected or coupled by connecting/coupling means 13a, preferably polyurethane shaft coupling 13b, such that when in rotation at inertially appropriate and/or sufficient-torque-producing rotational speed, the upsized drive shaft 13 inertially, amplifiably and/or exponentially adds its inertially generated input power/energy 15a″ to the motor 11′s subsequent mechanical input power/energy 15a′ derived from the subsequent electrical input power/energy 15a supplied to the motor 11. The resulting overall mechanical input power/energy 15d is efficiently converted/transformed by the generator/altemator 12 into electrical output power/energy 15 of a magnitude that is significantly and substantially greater than the electrical input power/energy 15a supplied to the motor 11. Further, the resulting overall input power/energy 15d is directly/exponentially proportional to the upsized drive shaft’s diameter D and/or length L, rotational speed, moment of inertia, and/or resultant torque.

For maximum electrical power/energy production and generation by the generator/altemator 12, the motor 11, and/or drive shaft 13 have their respective power generation capacities effectively and efficiently enhanced and/or amplified at least structurally, dimensionally, configuredly, component-wise, and/or material-wise such that the overall or sum total of the mechanical input power/energy 15d efficiently derived from the electric motor 11, i.e. the mechanical input power/energy 15a′, and the upsized drive shaft 13, i.e. the inertially generated input power/energy 15a″, is efficiently converted/ transformed by the generator/altemator 12 into the electrical output power/energy 15 of a magnitude that is significantly and substantially greater than the electrical input power/energy 15a supplied to the motor 11 as mentioned and discussed above and shown in FIG. 1, resulting in excess electrical output power that can be regulatively and practically converted into useful subsequent electrical power source(s) for supplying subsequent and sustainable input power/energy 15a to the motor 11 and other electrical loads 17 or for storing of power/energy such as the charging/recharging of the initial power source 14, i.e. the battery or battery pack 14′, used in the initial startup of the motor 11.

Summarily, the invention as disclosed and taught herein actually embodies in general and in principle an energy and power generation system or device that is mainly directed to the upsized drive shaft 13, one or plurality thereof. The shaft 13, which is adapted as one of the main and key elements of the system 10, comprises of an upsized main body 13″ of non-typical size having substantially and proportionately enlarged diameter D and/or length L based on typical standard drive shaft sizes normally and correspondingly adapted for power generation systems or devices of commensurate capacity ratings, preferably motor-generator system, generator or alternator, or electric motor. In the illustrative embodiment of the invention shown in FIG. 1, the upsized drive shaft 13 is about twice as big in diameter, i.e. with its diameter D of about 100 mm (4 in.), as the standard drive shaft 13′; and is much longer in length, i.e. with its length L of about 1,200 mm (1.2 m), than that of the typical standard drive shaft 13′ commonly used for motor-generator/altemator set-up or system.

The generator/altemator 12 has an effective area of its interactive magnet and coil winding components (not shown) that is substantially and proportionately greater in length L1, e.g. about 710 mm, than the length L2, e.g. about 500 mm, of the motor 11 or a typical generator/altemator of same capacity rating, and has a relatively same or smaller effective diameter D1, e.g. about 400 mm, than the diameter D2, e.g. about 300 mm - 350 mm, of the motor 11, such that the generator/alternator 12 has relatively more electromagnetic coil windings or longer magnetic field/flux area that efficiently translate into higher efficiency/capacity ratings. Further, the generator/altemator 12 is electrically connected to the motor 11 through a power management system 18 that electrically and/or eiectronicaiiy controls/manages the apportioning of the electrical output power/energy 15 of the generator/altemator 12 as subsequent electrical input power 15a to the motor 11, electrical input power 15c to the rechargeable battery or battery pack 14′, and/or electrical input power 15b supplying power to other electrical loads 17 such home lightings, appliances, gadgets, tools and other electrical power requirements/consumptions, among others, after startup as shown in FIG. 1.

The motor 11 and/or generator/altemator 12 have their permanent magnet components (not shown) being made of suitable magnetic materials such as, preferably, neodymium, neodynium-iron-boron, cobalt, samarium-cobalt, or any suitable magnetic materials or rare earth magnet materials, or any combinations of these materials, and more preferably, neodymium. For the coil winding wires of the motor 11 and/or generator/altemator 12, they are preferably made of suitable materials such as copper, brass, bronze, beryllium copper, aluminum, silver, gold, tungsten, zinc, or any suitable conductive materials, or any combinations of these wire materials.

In assembly, the drive shaft 13 is alignably, stably, and accurately mounted on mounting support means 19, connecting the motor 11 and generator/altemator 12 with an alignment accuracy of negligible, if not zero, deflection tolerance. The mounting support means 19 is in a form of anti-friction pillow block bearings 19a made of suitable materials such as cast steel/iron, metal alloy, ceramic, fiber-reinforced materials, or any suitable composite materials, or any combinations of these materials. The alignment, stability and accuracy/preciseness of the drive shaft 13 as installed/mounted on the mounting support means 19 or pillow block bearings 19a are of critical importance to the invention to ensure high efficiency motor-shaft-generator performance and high power/energy production. Hence, the system 10′s motor-shaft-generator set-up or assembly is installed with high-level installation accuracy or negligible, if not zero, margin of error tolerance.

For a high-efficiency performance and power/energy production or generation, the generator/alternator 12 is provided with a built-in or separate cooling means 20 with liquid and/or gaseous coolant or cooling medium selected from a group comprising of nitrogen, helium, air, glycol, argon, oxygen, neon, hydrogen, carbon dioxide, or any suitable cryogenic medium, and any mixtures thereof.

As shown in a schematic view or representation in FIG. 1, the power management system 18 is preferably in form of an uninterrupted power supply (UPS) unit 21 serving as main device for controlling/regulating, storing, distributing, allocating, converting and/or transforming the electrical power/energy output 15 from the generator/alternator 12 that is in communication with and/or includes therein electrical/electronic components and/or gadgets 22 such as rectifier 23, inverter 24, transformer(s) 25, surge protector 26, bypass/output/battery terminals and switches 27, electronic display screen and control panel 28, magnetic starter/contactor 29, motor speed (rpm) controller 16, battery or battery pack charger 23a, or any necessary gadgets, and any combinations of these gadgets/devices.

As the present invention is capable of being multiplied and interconnected together, one of the feasible and practical bigger-scale applications of the system 10 for providing a power-plant power/energy generation capacity in megawatt is a network-type assemblage or arrangement of a plurality of the system 10. When being multiplied in number and electrically connected in a network set-up, a plurality of the system 10 is capable of exponentially producing/generating useful output or excess power/energy of a power plant magnitude in megawatt or higher.

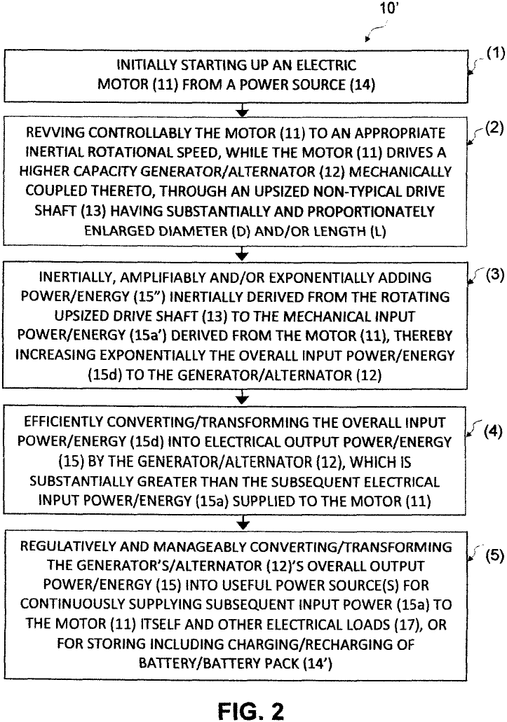

For the process aspect of the invention, there is shown in FIG. 2 a self-powered internal energy and power generation process 10′ comprising the following process steps with the elements thereof described in reference to FIG. 1:
(1) initially starting up the electric motor 11 from the power source 14;
(2) revving capably, controllably, and compatibly the motor 11 to an inertially appropriate and/or sufficient-torque-producing rotational speed, e.g. 600 - 700 rpm for the motor and generator capacities herein described, driving stably mounted and mechanically coupled generator/ alternator 12 with a higher power capacity rating than that of the motor 11, through the upsized drive shaft 13 of non-typical size having substantially and proportionately enlarged diameter D and/or length L based on typical standard generator or motor shaft sizes;
(3) inertially, amplifiably and/or exponentially adding inertially generated input power/energy 15″ by/from the upsized drive shaft 13, while being in the appropriate inertial rotational speed, to the subsequent mechanical input power/energy 15a′ derived from the motor 11, i.e. from the electrical input power/energy 15a supplied to the motor 11;
(4) efficiently converting and/or transforming the rotating shaft’s overall mechanical input power/energy 15d into electrical output power/energy 15 by the generator/alternator 12 of a magnitude that is significantly and substantially greater than the electrical input power/energy 15a supplied to the motor 11, and is directly and/or exponentially proportional to the upsized drive shaft 13′s diameter D and/or length L, rotational speed, moment of inertia, and/or resultant torque; and
(5) regulatively and manageably converting/transforming the generator’s/ alternator 12′s overall electrical output power/energy 15 into a useful power source apportionedly supplying subsequent and sustainable electrical input power/energy 15a to the motor 11 while in inertially appropriate rotation after startup, electrical input power/energy 15c for charging or recharging battery or pack of batteries 14′, and electrical input power/energy 15b for other electrical loads 17 or storage.

All the features of the system 10 and its elements as described and taught in the above description of the system 10 are all applied and covered in the process aspect 10′ of the invention, hence, the descriptions of these elements/features of the system 10 that are used for the limitations of the process 10′s dependent claims are not anymore repeated in the general description of the process 10′ considering that the use of the same numeral designations that refer to the same elements/features shown in FIG. 1 is sufficient enough for a clear and enabling disclosure and to avoid description redundancy and/or ambiguity.

As concrete example of the preferred embodiment of the invention disclosed, taught and described herein in detail, the following actual results are hereby shown below. The electric motor 11 used is a three-phase asynchronous AC motor with a capacity rating of 30 KVA (KW), 420 V, 59.5 A, 50 Hz, 289 Nm and 980 rpm, and the generator/altemator 12 used is also a three-phase asynchronous AC alternator with a relatively higher capacity rating of 100 KVA, 600 V, 96 A, 60 Hz, 235 Nm and 750 rpm. The motor 11 drives the alternator 12 through the upsized drive shaft 13 with diameter D of 4 in. (101.6 mm) and length L of 1,200 mm (1.2 m) stably and alignably mounted on the pillow block ceramic bearings. The power management system 18, i.e. the UPS system/unit 21, used has a rating of 660 V (AC) +/- 25% input, 44 V (AC) +/-10% output and 100 A charging capacity to the pack of 12 pcs. 12 V (DC) and 200 Ah batteries.
At a speed of 620 rpm and subsequent electrical input power 15a of 21.20 kw (309 V, 39.2 A) supplied to the motor 11, the electrical output power 15 produced/generated by the alternator 12 is 46.55 kw (380 V, 70 A) for an output/input percentage ratio of 220% and an excess output (for other loads)/input percentage ratio of 120%;
At a speed of 640 rpm and subsequent electrical input power 15a of 22.55 kw (362 V, 35.6 A) supplied to the motor 11, the electrical output power 15 produced/generated by the alternator 12 is 36.12 kw (480 V, 43 A) for an output/input percentage ratio of 160% and an excess output (for other loads)/input percentage ratio of 60%;
At a speed of 732 rpm and subsequent electrical input power 15 a of 6 kw (434 V, 7.9 A) supplied to the motor 11, the electrical output power 15 produced/generated by the alternator 12 is 13.94 kw (450 V, 17.7 A) for an output/input percentage ratio of 232% and an excess output (for other loads)/input percentage ratio of 132%;
At a speed of 732 rpm and subsequent electrical input power 15 a of 5.33 kw (435 V, 7 A) supplied to the motor 11, the electrical output power 15 produced/generated by the alternator 12 is 11.99 kw (466 V, 14.7 A) for an output/input percentage ratio of 225% and an excess output (for other loads)/input percentage ratio of 125%; and
At a speed of 732 rpm and subsequent electrical input power 15a of 5.3 kw (433 V, 7 A) supplied to the motor 11, the electrical output power 15 produced/generated by the alternator 12 is 11.78 kw (426 V, 15.8 A) for an output/input percentage ratio of 222% and an excess output (for other loads)/input percentage ratio of 122%.

Before defining the scope of the following claims, it is to be understood that the invention is not limited in its applications to the details of the illustrative examples or variations set forth in the preceding description and drawings. It is to be noted that the invention is capable of other variations and limitless applications not disclosed herein. Further, this invention is likewise capable of being practiced and carried out in various ways falling within the teaching and scope of the following claims.

1. A self-powered internal energy and power generation system comprising:
an electric motor initially powered or started up by a power source, and subsequently and sustainably powered by part of an output power/energy produced or generated by the system;
a generator/alternator having higher power capacity rating than that of said motor, and being capably, controllably, and compatibly driven rotatably by said motor; and
an upsized drive shaft of non-typical size having substantially and proportionately enlarged diameter and/or length such that said shaft has a relatively greater resultant mass and moment of inertia than standard-size drive shaft, and stably connecting said motor and said generator/alternator such that when in rotation, said upsized drive shaft inertially, amplifiably and/or exponentially adds power/energy to a subsequent mechanical input power/energy derived from said motor; the resulting overall input power/energy being efficiently converted/transformed by said generator/alternator into electrical output power/energy of a magnitude that is significantly and substantially greater than the electrical input power/energy supplied to said motor, and is directly/exponentially proportional to the upsized drive shaft’s diameter and/or length, rotational speed, moment of inertia, anti/or resultant torque.

2. A self-powered internal energy and power generation system comprising:
an electric motor initially powered or started up by a power source, and subsequently and sustainably powered by part of an output power/energy produced or generated by the system;
a generator/alternator having higher power capacity rating than that of said motor, and being capably, controllably, and compatibly driven rotatably by said motor; and
wherein said motor, drive shaft, and/or generator/alternator have their power generation capacities effectively and efficiently enhanced and/or amplified at least structurally, dimensionally, configuredly, component-wise, and/or material-wise such that a sum of input power/energy efficiently derived from said electric motor and/or said shaft is efficiently converted/transformed by said generator/alternator into electrical output power/energy of a magnitude that is significantly and substantially greater than the electrical input power supplied to said motor, resulting in excess electrical output power that can be regulatively and practically converted into a useful power source(s) supplying sustainable subsequent input power to said motor and other electrical loads or for storage after startup.

3. An energy and power generation system or device having at least one upsized drive shaft adapted as one of the main elements thereof comprising an upsized main body of non-typical size having substantially and proportionately enlarged diameter and/or length based on typical standard drive shaft sizes normally and correspondingly adapted for power generation systems or devices of commensurate capacity ratings, preferably motor-generator system, generator or alternator, or electric motor.

4. The system according to claim 1, wherein said generator/alternator has an effective area of its interactive magnet and coil winding components that is substantially and proportionately greater in length than that of said motor or a typical generator/alternator; and has a relatively same or smaller effective diameter than that of said motor, such that said generator/alternator has relatively more electromagnetic coil windings or longer magnetic field/flux area that efficiently translate into higher efficiency and capacity ratings.

5. The system according to claim 1, wherein said generator/alternator is electrically connected to said motor through a power management system that electrically and/or electronically controls/manages the apportioning of the electrical output power of said generator/alternator as subsequent electrical input power to said motor, rechargeable battery or battery pack, and/or other electrical loads/storage after startup.

6. The system according to claim 1, wherein said motor and/or generator/alternator have their permanent magnet components being made of suitable magnetic materials selected from a group comprising of neodymium, neodynium-iron-boron, cobalt, samarium-cobalt, or any suitable magnetic materials or rare earth magnet materials, and any combination thereof.

7. The system according to claim 1, wherein said motor and/or generator/alternator have their coil winding wires being made of suitable materials selected from a group comprising of copper, brass, bronze, beryllium copper, aluminum, silver, gold, tungsten, zinc, or any suitable conductive materials, and any combination thereof.

8. The system according to claim 1, wherein said drive shaft is alignably, stably, and accurately mounted on mounting support means, connecting said motor and generator/alternator with an alignment accuracy of negligible, if not zero, deflection tolerance.

9. The system according to claim 8, wherein said mounting support means is in a form of anti-friction pillow block bearings made of suitable materials selected from a group comprising of cast steel/iron, metal alloy, ceramic, fiber-reinforced materials, or any suitable composite materials, and any combinations thereof.

10. The system according to claim 1, wherein said generator/alternator is provided with a built-in or separate cooling means with liquid and/or gaseous coolant or cooling medium selected from a group comprising of nitrogen, helium, air, glycol, argon, oxygen, neon, hydrogen, carbon dioxide, or any suitable cryogenic medium, and any mixtures thereof.

11. The system according to claim 5, wherein said power management system is in a form of an uninterrupted power supply (UPS) unit as main device for controlling/regulating, storing, distributing, allocating, converting and/or transforming the power output from said generator/alternator that is in communication with and/or includes therein electrical/electronic components and/or gadgets selected from a group comprising of rectifier, inverter, surge protector, bypass/output/battery terminals and switches, electronic display screen and control panel, magnetic starter/contactor, motor speed (rpm) controller, battery or battery pack charger, or any necessary gadgets, and any combinations thereof.

12. The system according to claim 1, wherein said power source for supplying initial start-up power to said electric motor is in form selected from a group comprising of battery or battery pack, grid, or any forms or types of electrical power-generating sources, and any combinations thereof.

13. The system according to claim 1, wherein said system is capable of being multiplied in number and electrically connected in a network setup for exponentially producing useful excess power output of a power plant magnitude.

14. A self-powered internal energy and power generation process comprising the steps of:
initially starting up an electric motor from a power source;
revving capably, controllably, and compatibly said motor to an inertially appropriate and/or sufficient-torgue-producing rotational speed, driving a stably mounted and mechanically coupled generator/alternator with a higher power capacity rating than that of said motor, through an upsized drive shaft of non-typical size having substantially and proportionately enlarged diameter and/or length based on typical standard generator or motor shaft sizes; inertially, amplifiably and/or exponentially adding inertiaiiy generated power/energy derived from the rotating said upsized drive shaft, which is of a magnitude that is directly and/or exponentially proportional to the upsized drive shaft’s diameter and/or length, to a mechanical input power/energy derived from said motor rotational speed, moment of inertia, and/or resultant torque, increasing exponentially the overall input power/energy to said generator/alternator;
efficiently converting and/or transforming the rotating shaft’s overall mechanical power/energy by said generator/alternator into electrical output power/energy of a magnitude that is significantly and substantially greater than the electrical input power/energy supplied to said motor; and
regulatively and manageably converting/transforming the generator’s/ alternator’s overall output power/energy into useful power source(s) for apportionedly and continuously supplying subsequent and sustainable electrical input power to said motor while in inertially appropriate rotation after startup, and other electrical loads, or for storing, including charging/recharging of battery or pack of batteries.

15. The process according to claim 14, wherein said generator/alternator has substantially longer dimensional length for a given standard diametrical size resulting in relatively longer electromagnetic coil winding and effective magnetic flux area that translate into proportionately greater output power generation; and/or wherein said electric motor is relatively and dimensionally smaller than said generator/alternator such that said motor needs lesser amount of power input in rotatably and sustainably driving said generator/alternator through said drive draft acceleratively and/or constantly.

16. The process according to claim 14, wherein said motor and/or generator/alternator have their permanent magnet components being made of suitable magnetic materials selected from a group comprising of neodymium, neodynium-iron-boron, cobalt, samarium-cobalt, or any suitable magnetic materials or rare earth magnet materials, and any combination thereof.

17. The process according to claim 14, wherein said motor and/or generator/alternator have their coil winding wires being made of suitable materials selected from a group comprising of copper, brass, bronze, beryllium copper, aluminum, silver, gold, tungsten, zinc, or any suitable conductive materials, and any combination thereof.

18. The process according to claim 14, wherein said drive shaft is stably, accurately and alignably mounted on a mounting support means with negligible, if not zero, deflection tolerance relative to the motor’s and generator/alternator’s rotor shaft alignment.

19. The process according to claim 18, wherein said mounting support means is in a form of anti-friction pillow block bearings made of suitable materials selected from a group comprising of cast steel/iron, metal alloy, ceramic, fiber-reinforced materials, or any suitable composite materials, and any combinations thereof.

20. The process according to claim 14, wherein said generator/alternator is provided with a built-in or separate cooling means with liquid and/or gaseous coolant or cooling medium selected from a group comprising of nitrogen, helium, air, glycol, argon, oxygen, neon, hydrogen, carbon dioxide, or any suitable cryogenic medium, and any mixtures thereof.

21. The process according to claim 14, wherein there is provided a power management system in a form of an uninterrupted power supply (UPS) unit as main device for controlling/regulating, storing, distributing, allocating, converting and/or transforming the power output from said generator/alternator that is in communication with and/or includes therein electrical/electronic components and/or gadgets selected from a group comprising of rectifier, inverter, surge protector, bypass/output/battery terminals and switches, electronic display screen and control panel, magnetic starter/contactor, motor speed (rpm) controller, battery or battery pack charger, or any necessary gadgets, and any combinations thereof.

22. The process according to claim 14, wherein said power source for supplying initial or start-up power to said electric motor is in form selected from a group comprising of battery or battery pack, grid, or any forms or types of electrical power-generating sources, and any combinations thereof.

23. The process according to claim 14, wherein said process is capable of being multiplied in number and electrically connected in a network setup for exponentially producing useful excess power output of a power plant magnitude.

24. The system according to claim 2, wherein said generator/alternator has an effective area of its interactive magnet and coil winding components that is substantially and proportionately greater in length than that of said motor or a typical generator/alternator; and has a relatively same or smaller effective diameter than that of said motor, such that said generator/alternator has relatively more electromagnetic coil windings or longer magnetic field/flux area that efficiently translate into higher efficiency and capacity ratings.

25. The system according to claim 2, wherein said generator/alternator is electrically connected to said motor through a power management system that electrically and/or electronically controls/manages the apportioning of the electrical output power of said generator/alternator as subsequent electrical input power to said motor, rechargeable battery or battery pack, and/or other electrical loads/storage after startup.

26. The system according to claim 3, wherein said generator/alternator has an effective area of its interactive magnet and coil winding components that is substantially and proportionately greater in length than that of said motor or a typical generator/alternator; and has a relatively same or smaller effective diameter than that of said motor, such that said generator/alternator has relatively more electromagnetic coil windings or longer magnetic field/flux area that efficiently translate into higher efficiency and capacity ratings.

27. The system according to claim 3, wherein said generator/alternator is electrically connected to said motor through a power management system that electrically and/or electronically controls/manages the apportioning of the electrical output power of said generator/alternator as subsequent electrical input power to said motor, rechargeable battery or battery pack, and/or other electrical loads/storage after startup.
